(19) United States
(12) Patent Application Publication
(10) Pub. No.: US 2026/0369991 A1
(43) Pub. Date: Nov. 19, 2026

(54) CIRCUITRY SYSTEM FOR WIRELESS DEVICE AND WIRELESS DEVICE COMPRISING THE SAME

(71) Applicant: HEWLETT PACKARD ENTERPRISE DEVELOPMENT LP, Spring, TX (US)

(72) Inventors: Jiguang Zheng, Beijing (CN); Tian Wang-Mendez, San Jose, CA (US); Jie Gao, Beijing (CN); Shaohui Jiang, Beijing (CN)

(21) Appl. No.: 19/208,935

(22) Filed: May 15, 2025

(51) Int. Cl. H02H 9/04; H02H 1/00

(52) U.S. Cl. CPC H02H 9/04; H02H 1/0007

(57) ABSTRACT

Implementations of the present disclosure relate to circuitry system for a wireless device. The circuitry system includes a first detection line connected between a first terminal and the powered device chip. The first terminal is configured to receive a first test voltage during a high potential (Hi-Pot) test or a surge test. The circuitry system further includes a second detection line connected between a second terminal and the powered device chip. The second terminal is configured to receive a second test voltage. A voltage difference between these two lines is associated with a differential mode voltage between the first terminal and the second terminal. The circuitry system further includes: a voltage clamping component configured to clamp the voltage difference to be lower than a rated voltage of the powered device chip; and a surge energy absorbing circuit configured to absorb surge energy during the surge test.

### BACKGROUND

During a high potential (Hi-Pot) test, in which high voltage is applied to the Ethernet terminals of a wireless access point device to verify that the insulation of the wireless device can withstand high voltages without breaking down, a ground-connected surge protection device (for example, a transient voltage suppressor (TVS), a gas discharge tube, or a metal oxide varistor) needs to be removed temporarily. Otherwise, the high voltage will be conducted to the ground via the ground-connected surge protection device, and the Hi-Pot test cannot be passed. Thus, the routine procedure of the Hi-Pot test needs to be conducted after depopulation of the ground-connected surge protection device (for example, a TVS). The wireless device deployed in the field is typically unable to handle both surges and Hi-Pot risks simultaneously due to the existence of a grounded-connected surge protection device. Once the Hi-Pot test is completed and passed, these surge protection devices need to be repopulated to the wireless device. The addition of these TVS depopulation, verification, and repopulation processes significantly impact mass production efficiency and increase manufacturing costs.

### BRIEF DESCRIPTION OF THE DRAWINGS

Through the following detailed descriptions with reference to the accompanying drawings, the above and other objectives, features, and advantages of the example implementations disclosed herein will become more comprehensible. In the drawings, several example implementations disclosed herein will be illustrated in an example and non-limiting manner, where:

FIG. 1A is a schematic view of a wireless device according to some example implementations of the present disclosure;

FIG. 1B is a schematic view of a wireless device including a circuitry system for enabling both Hi-Pot test and surge test for the wireless device according to some example implementations of the present disclosure;

FIG. 2 is a schematic view showing a circuitry system according to some example implementations of the present disclosure;

FIG. 3 is a schematic view showing a specific structure of a circuitry system according to some example implementations of the present disclosure;

FIG. 4 is a schematic view showing a wireless device having a common mode suppression circuit according to some example implementations of the present disclosure;

FIG. 5 is a schematic flow chart of a process for performing a Hi-Pot test and a surge test on a wireless device according to some example implementations of the present disclosure; and

FIG. 6 is a schematic view of performing a Hi-Pot test and a surge test on a wireless device according to some example implementations of the present disclosure.

### DETAILED DESCRIPTION

In an electrical device (e.g., a wireless device), typically, in order to prevent surge current from damaging the device, one or more surge protection devices are installed, such as transient voltage suppressors (TVSs), gas discharge tubes (GDTs), and metal oxide varistors (MOVs). For example, a TVS is a semiconductor device specifically used to protect an electronic device from transient high-voltage damage. It has a relatively fast response speed, and the working principle of the TVS is based on the reverse breakdown characteristics of the PN junction. For example, the TVS may be connected between a power line (for example, a center tap of a transformer of a Ethernet terminal) and the ground or connected between a data line and the ground.

When the voltage across the TVS is less than its breakdown voltage, the TVS may act as a very large resistor in a cut-off state. When the voltage across the TVS exceeds the breakdown voltage, the TVS will quickly turn on and present a low impedance state, thereby conducting the surge energy to the ground, and preventing the surge energy from damaging the wireless device. For example, when the wireless device (for example, a power line, or the center tap) is subjected to a surge current (e.g., a lightning strike), the voltage across the TVS exceeds its breakdown voltage, and the TVS will quickly turn on, presenting a low impedance state, thereby conducting the surge energy to the ground.

Hi-Pot (High-Potential) test, also known as withstand voltage test, is an electrical safety test method, that is used to detect whether electrical devices or circuits can work normally when subjected to a voltage higher than the normal working voltage, and whether there are safety hazards such as insulation damage. A current detection device can accurately detect the leakage current generated during this process to determine whether the device has leakage hazards. That is to say, the Hi-Pot test is to detect whether the insulation performance is good by applying a high voltage between different electrodes of the device under test and detecting a leakage current of the wireless device. For example, for the wireless device, the high voltage is applied to the Ethernet terminal of the wireless device.

However, for example, the function of a grounded TVS is to conduct the surge energy to the ground, when the transient voltage exceeds a certain value. In the Hi-Pot test, if the grounded TVS is not removed, the grounded TVS may turn on to conduct the current to the ground, before the test voltage reaches the insulation breakdown voltage of the device, causing a current test device used during the Hi-Pot test to detect the current and mistakenly believe that there is an insulation problem with the device, resulting in a misjudgment of insulation performance of the device. Thus, removing the grounded TVS can ensure that the high voltage applied by the Hi-Pot test can actually act on the insulation part of the device, so as to accurately detect whether there are potential defects in the insulation of the device, such as damage and aging of the insulating material.

Therefore, in the conventional test method, in order to perform the Hi-Pot test, there are a lot of operation steps. In the first step, all installations are completed, and other functional tests are passed (e.g., electromagnetic shielding test and surge protection test). In the second step, a tester removes the grounded surge protection device (e.g., TVS). In the third step, the Hi-Pot test is performed with the grounded TVS removed. In the fourth step, after the Hi-Pot test is passed, the surge protection device (e.g., TVS) is reinstalled into the wireless device to be grounded. In the fifth step, after the surge protection device (e.g., TVS) is reinstalled, the entire wireless device is shipped.

Therefore, in the conventional method, the steps of disassembling and reinstalling surge protection devices (such as TVS) increase the complexity of the operation. In the process of disassembling and installing surge protection devices, the devices will inevitably be subjected to certain mechanical stress or electrical shock due to the need to plug, unplug, solder, or perform other connection operations. Repeated operations may gradually reduce the performance of the device or even directly damage the device. Complex test steps require more manpower input, including the operating time of testers and the cost of supervision and management. At the same time, a longer test cycle will increase the time the device stays on the production line, affecting the production efficiency and delivery speed of the product, and reducing the production efficiency.

In view of the foregoing, an example implementation of the present disclosure provides a circuitry system that enables a wireless device to perform a high voltage withstand test and a surge protection test simultaneously, i.e., performing the Hi-Pot test and the surge protection test without removing any components. The wireless device includes multiple terminals and a powered device chip. The circuitry system includes: a first detection line connected between a first terminal of the plurality of terminals and the powered device chip, the first terminal being configured to receive a first test voltage during a high potential (Hi-Pot) test or a surge test; and a second detection line connected between a second terminal of the plurality of terminals and the powered device chip, the second terminal being configured to receive a second test voltage during the Hi-Pot test or the surge test. A voltage difference between the first detection line and the second detection line is associated with a differential mode voltage between the first terminal and the second terminal. The circuitry system further includes a voltage clamping component connected between the first detection line and the second detection line and configured to clamp the voltage difference to be lower than a rated voltage of the powered device chip. The circuitry system further includes a surge energy absorbing circuit configured to be connected to the first detection line and the second detection line to absorb the surge energy during the surge test. Since the grounded surge protection device is permanently removed, the wireless device can be subject to a Hi-Pot test to detect the insulation performance of its components by directly applying high voltage to the network terminals of the wireless device without disassembling or installing any components of the finished wireless device. In addition, by providing a voltage clamping component and a surge energy absorption circuit, the powered device chip can be protected, and the surge energy can be sufficiently absorbed during the surge test, so as to further protect the powered device chip and other components of the wireless device.

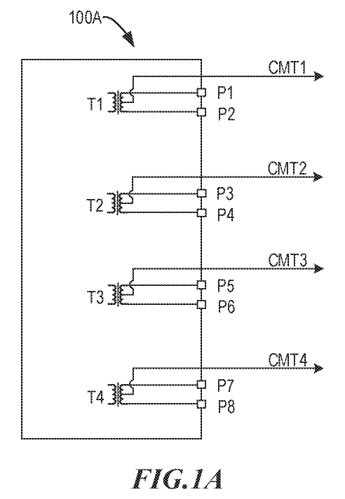

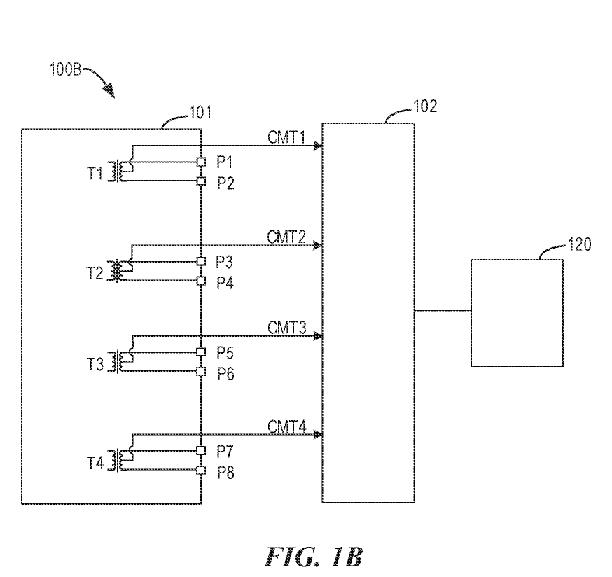

FIG. 1A shows a schematic view of a wireless device according to some example implementations of the present disclosure.

As shown in FIG. 1A, the wireless device 100A includes a number of Ethernet terminals, for example, eight Ethernet terminals, namely, P1, P2, P3, P4, P5, P6, P7, and P8. Each of the Ethernet terminals is connected to an Ethernet cable. For example, the wireless device can be provided with eight standard RJ45 Ethernet cable terminals. Every two adjacent Ethernet terminals share a center tap. Therefore, the wireless device 100A includes four center taps, namely, CMT1, CMT2, CMT3, and CMT4. The center tap is generally the middle connection point on the Ethernet terminal transformer winding. For example, CMT1 is the middle connection point of a transformer winding T1. CMT2 is the middle connection point of a transformer winding T2. CMT3 is the middle connection point of a transformer winding T3. CMT4 is the middle connection point of a transformer winding T4. The center tap is used to realize functions such as signal conversion, balancing, and common mode noise suppression through a specific circuit design.

FIG. 1B is a schematic view of a wireless device 100B comprising a circuitry system for enabling both Hi-Pot test and surge test for the wireless device according to some example implementations of the present disclosure.

As shown in FIG. 1B, the wireless device 100B includes a wireless device body 101, a circuitry system 102, and a powered device chip 120. Merely for the purpose of illustrating the connection of the center taps (for example, CMT1, CMT2, CMT3, and CMT4) to the circuitry system 102 and the connection of the circuitry system 102 to the powered device chip 120, the circuitry system 102 and the powered device chip 120 are shown outside the wireless device body 101. The circuitry system 102 and the powered device chip 120 are disposed inside the wireless device body 101, and are provided as part of a printed circuit board of the wireless device 100B. The circuitry system 102 is connected between at least two of the four center taps (i.e. CMT1, CMT2, CMT3, and CMT4) and the powered device chip 120, and may allow to perform both Hi-Pot test and surge test for the wireless device 100B without disassembly and reassembly of any component thereof. For example, in a Power over Ethernet (PoE) system, when wireless devices consume less than 15W, two center taps are used during the test according to 802.3af standard, whereas when wireless devices consume more than 15W, the four taps will all used according to 802.3at, 802.3bt standard.

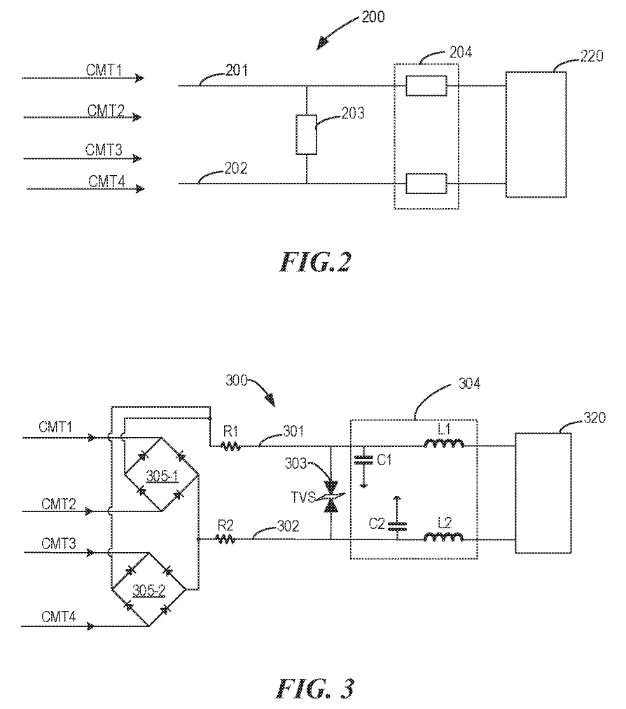

Hereinafter, some example implementations of the circuitry system will be described with reference to FIGS. 2 and 3.

FIG. 2 shows a schematic view of a circuitry system 200 that allows simultaneous Hi-Pot test and surge test of a wireless device according to some example implementations of the present disclosure. It should be understood that the simultaneous Hi-Pot test and surge test means that there is no other disassembling and reinstalling operation between the Hi-Pot test and the surge test, and that both tests can be performed on the finished wireless device. As shown in FIG. 2, the circuitry system 200 corresponds to the circuitry system 102 of FIG. 1, and the powered device chip 220 corresponds to the powered device chip 120 of FIG. 1.

When performing a Hi-Pot test on the wireless device, a high voltage (e.g., 1000V, 1500V, or even 4000V) may be continuously applied to some or all of the eight Ethernet terminals, for example, for at least one minute, to test the insulation between the Ethernet terminal and the ground or other reference potential. When the high voltage is applied to the Ethernet terminal, a corresponding high voltage also appears on the center tap of the Ethernet terminal transformer associated with the Ethernet terminal.

In one example implementation where two center taps are used, high voltage is applied to four (for example, P1, P2, P3, and P4) of the eight Ethernet terminals P1, P2, P3, P4, P5, P6, P7, and P8, so that the applied high voltage is output from two center taps (CMT1 and CMT2) respectively. In one example, high voltage is applied to the eight Ethernet terminals, so that the applied high voltage is output from four center taps CMT1, CMT2, CMT3, and CMT4, respectively. During the Hi-Pot test, the wireless device is powered off and is not in a working state. In some example implementations where four center taps are used, when eight Ethernet terminals are connected together, a common high voltage (e.g., 1000V, 1500V or even 4000V) is applied to the eight Ethernet terminals, so that the simultaneity of voltage application to the eight Ethernet terminals can be ensured, and that the voltage output from the four center taps can be equal.

During the surge test, a transient high voltage is applied to the wireless device in working state for a short time (for example, ten microseconds with one second interval therebetween), and the transient high voltage may be different from the voltage during the Hi-Pot test.

As shown in FIG. 2, the circuitry system 200 described in the present disclosure is connected between the four center taps (CMT1, CMT2, CMT3, and CMT4) and the powered device chip 220. In some example implementations, the powered device chip 220 is located inside the wireless device. In FIG. 2, the powered device chip 220 is shown separately and outside the wireless device to merely illustrate the connection between the circuitry system described in the present disclosure and the wireless device. During the Hi-Pot test and the surge test, it is preferable to ensure that the powered device chip 220 is not affected by large voltages and large currents.

As shown in FIG. 2, the circuitry system 200 includes a first detection line 201 and a second detection line 202. The first detection line 201 is connected between a first terminal among a number of terminals and the powered device chip 220. The second detection line 202 is connected between a second terminal among a number of terminals and the powered device chip 220. The first detection line and the second detection line may be power wiring or other routing wiring between the Ethernet terminal and the powered device chip on a printed circuit board of a wireless device. In some examples, the detection line is connected to the terminal via a diode bridge.

In some example implementations, the terminal connected to the detection line may be the center tap of the transformer of the Ethernet terminal. For example, in a first test, the first detection line 201 may be connected between one center tap (e.g., CMT1) of four center taps (for example, CMT1, CMT2, CMT3, and CMT4) and the powered device chip 220. The second detection line 202 may be connected between another center tap (e.g., CMT2) of the four center taps (for example, CMT1, CMT2, CMT3, and CMT4) and the powered device chip 220. Then, in the next test, the first detection line 201 may be connected between CMT3 and the powered device chip 220, and the second detection line 202 may be connected between CMT4 and the powered device chip 220. In some examples, the detection line is connected to the center tap via a diode bridge. Therefore, the insulation inspection of all terminals can be completed through two tests.

However, in some other example implementations, the first detection line 201 may be connected between two center taps (e.g., CMT1 and CMT2) and the powered device chip 220, and the second detection line 202 may be connected between the other two center taps (e.g., CMT3 and CMT4) and the powered device chip 220. In some examples, the detection line is connected to the center taps via the diode bridge. Therefore, the insulation inspection of all terminals is completed through one test.

The voltage difference between the first detection line 201 and the second detection line 202 is related to the differential mode voltage between the first terminal (e.g., the center tap connected to the first Ethernet terminal) and the second terminal (e.g., the center tap connected to the second Ethernet terminal). In other words, the voltage difference between the first detection line 201 and the second detection line 202 is related to the differential mode voltage between two center taps.

During the Hi-Pot test, since the eight Ethernet terminals receive a common voltage, the voltages on the center taps are substantially equal, so that there is substantially no voltage difference between the first detection line 201 and the second detection line 202. Even if a voltage difference occurs on the first detection line 201 and the second detection line 202, the voltage difference is relatively small and is smaller than the breakdown voltage of the voltage clamping device (to be described later). During the Hi-Pot test, a current detection device can detect the leakage current between the Ethernet terminal, to which the high voltage is applied, and the ground, between the first detection line and the ground, or between the second detection line and the ground.

However, during the surge test, the wireless device is still in the working state. Moreover, the instantaneous voltages between the eight Ethernet terminals may be inconsistent. Therefore, during the surge test, there may be a voltage difference between the voltages on the four center taps, and a voltage difference may appear between the first detection line 201 and the second detection line 202, which is related to the differential mode voltage between the Ethernet terminals or between the center taps.

As shown in FIG. 2, the circuitry system 200 further includes a voltage clamping component 203, which is connected between the first and second detection lines to clamp the voltage difference between the first detection line and the second detection line to a voltage lower than the rated voltage (e.g., 100V) of the powered device chip 220. The voltage clamping component 203 may clamp the voltage difference between the first detection line 201 and the second detection line 202 when a differential mode voltage appears during a surge test. However, during the Hi-Pot test, since there is no voltage difference or little voltage difference between the first detection line 201 and the second detection line 202, the voltage applied to the powered device chip 220 from the two lines may not exceed the rated voltage of the chip 220.

As shown in FIG. 2, the circuitry system 200 according to some example implementations of the present disclosure further includes a surge energy absorption circuit 204 (shown by the dotted line block), which is configured to be connected to the first detection line 201 and the second detection line 202, so as to absorb instantaneous surge energy during the surge test. By setting the surge energy absorption circuits in the circuitry system 200, the instantaneous surge energy can be absorbed during the surge test so as to protect the powered device chip 220.

As shown in FIG. 2, in an example implementation according to some example implementations of the present disclosure, the grounded TVS is permanently removed, so that during the Hi-Pot test, when a high voltage is applied to the network terminal, the high voltage will not be conducted to the ground through the grounded TVS. Therefore, the Hi-Pot test can be performed without removing any components in advance. In addition, during the surge test, the voltage applied to the powered device chip can be clamped to a relatively small voltage by the voltage clamping component, thereby protecting the powered device chip. In addition, the surge energy absorption circuit provided can also absorb instantaneous surge energy during the surge test.

FIG. 3 shows a circuit diagram of a circuitry system 300 according to some example implementations of the present disclosure. As shown in FIG. 3, the first detection line 301 corresponds to the first detection line 201 of FIG. 2. The second detection line 302 corresponds to the second detection line 202 of FIG. 2. The powered device chip 320 corresponds to the powered device chip 220 of FIG. 2. The voltage clamping component 303 corresponds to the voltage clamping component 203 of FIG. 2. The surge energy absorption circuit 304 corresponds to the surge energy absorption circuit 204 of FIG. 2.

In some example implementations, the voltage clamping component 303 includes a transient voltage suppressor (TVS) connected between the first detection line 301 and the second detection line 302. In doing so, during the surge test, the voltage between the first detection line 301 and the second detection line 302 is clamped to prevent excessive voltage from being input into the powered device chip 320. A transient voltage suppressor is a component used to protect a circuit from transient high-voltage damage. When a transient high voltage appears in the circuit, the voltage across the TVS will rise rapidly. When the voltage across the TVS reaches the breakdown voltage of the TVS, the TVS will undergo an avalanche breakdown or a Zener breakdown and enter a conducting state. When the transient voltage disappears, the current in the TVS gradually decreases. When the current decreases to a certain extent, the TVS will return to the cut-off state and present a high resistance again. In one example implementation, the breakdown voltage of the TVS can be set to 60V, and the breakdown voltage is set to be less than the rated voltage (for example, 100V) of the powered device chip 320.

In the conducting state, the TVS may act as a low impedance path that allows current to pass. In a conventional wireless device, the TVS is connected between the wireless device and the ground, so that when surge energy occurs, the TVS is turned on, thereby transferring the surge energy to the ground. In an example implementation of the present disclosure, the TVS is no longer grounded, but is connected between the first detection line 301 and the second detection line 302.

When performing the Hi-Pot test, a common high voltage is applied between different Ethernet terminals, so the voltage on the first detection line 301 is the same as the voltage on the second detection line 302. At this time, the TVS will not turn on. Therefore, the presence of the TVS will not affect the detection of leakage current during the Hi-Pot test.

For example, during a surge test, the voltages between different terminals may be not the same, and there may be certain voltage differences, resulting in a difference between a first voltage on the first detection line 301 and a second voltage on the second detection line 302. If the voltage difference between the first detection line and the second detection line is less than the breakdown voltage of the TVS (e.g., 60V), the TVS will present a high impedance.

However, during the surge test, when the voltage difference between the first detection line 301 and the second detection line 302 exceeds the breakdown voltage (e.g., 60V) of the TVS, the TVS is turned on. Then the TVS will present a low impedance and clamp the voltage at both ends to a relatively stable lower voltage value, that is, the clamping voltage. In one example implementation, the clamping voltage is 1.1 to 1.5 times the breakdown voltage, which, for example, may be in the range of 66V to 90V. Moreover, the clamping voltage is less than the rated voltage of the powered device chip 320 (e.g., 100V).

Because this clamping voltage is lower than the maximum or rated voltage that the protected device (for example, the powered device chip 320) can withstand, it effectively protects components in the circuit from being damaged by excessive voltage. For example, when a large instantaneous differential mode voltage appears on the first detection line 301 and the second detection line 302, the TVS may cause the instantaneous voltage applied to the powered device chip 320 to be the clamping voltage, which is lower than the rated voltage of the powered device chip 320, so that the powered device chip 320 can work normally.

As shown in FIG. 3, in one example implementation, the surge energy absorption circuit 304, which is shown by the dotted line block, includes LC circuits. In some example implementations, the first LC circuit may include a first inductor L1 serially connected between the first detection line 301 and the powered device chip 320, and a first capacitor C1 connected between the first detection line 301 and the ground. The second LC circuit may include a second inductor L2 serially connected between the second detection line 302 and the powered device chip 320, and a second capacitor C2 connected between the second detection line 302 and the ground.

Since the inductor has the characteristic of hindering the change of current, when a transient current occurs, the rapid change of the current will cause the inductor to generate a back electromotive force, the direction of which is opposite to the direction of the current change. Therefore, the inductor may hinder the rapid increase of the current and limit the peak value of the transient current. At the same time, the inductor may also convert part of the electrical energy into magnetic energy and store it, reducing the energy used to generate the transient current. Therefore, the first inductor L1 and the second inductor L2 can prevent the increase of transient surge current and limit the peak value of the surge current—that is, part of the electrical energy of the surge current is converted into magnetic energy and stored, thereby protecting the powered device chip 320.

Further, when an excessively large transient surge current occurs, the first capacitor C1 and the second capacitor C2 will be charged, storing the electrical energy as electric field energy, thereby limiting the sudden increase in current. When the current in the circuit decreases, the first capacitor C1 and the second capacitor C2 will release the stored charge to maintain the current in the circuit, making the current change more stable.

In some example implementations, to ensure that the Hi-Pot test and the surge test can be performed, each of the first capacitor C1 and the second capacitor C2 has a voltage capability that may withstand a voltage higher than the maximum voltage during the Hi-Pot test and the surge test. For example, a voltage capacity capable of withstanding about 4kV may be designed for each of the first capacitor C1 and the second capacitor C2.

In some example implementations, the distance between the two pins of the first capacitor C1 or the second capacitor C2 is greater than the creepage distance between the power line (e.g., the Ethernet terminal of the wireless device, the first detection line, or the second detection line) and the ground during the Hi-Pot test and the surge test.

In some example implementations, the current carrying capacity of the first inductor L1 and the second inductor L2 is higher than the current during the Hi-Pot test and the surge test. In this way, it can prevent the first inductor L1 and the second inductor L2 from producing too much heat, and further prevent the first inductor L1 and the second inductor L2 from entering a saturated state, since after the magnetic core is saturated, the inductance of the inductor will drop sharply and lose its effective suppression effect on the current. Thus, by ensuring that the inductor’s current-carrying capacity is higher than the test current, it can avoid saturation of the magnetic core during the test and ensure the normal operation of the inductor.

In some other example implementations, the surge energy absorption circuit 304 may further comprise additional resistors or parasitic resistors R1 and R2 configured to absorb part of surge energy. For example, the resistors R1 and R2 may be provided on the first and second detection lines or any other connecting lines. Although as shown in FIG. 3, the additional resistors or parasitic resistor R1 and R2 are shown on the detection lines 301 and 302, the additional resistors or parasitic resistors may exist throughout the connecting lines, for example, at connectors, at routing lines on the PCB, at devices of the diode bridges, at the external network cables and the like. The resistors R1 and R2 may have the resistance less than one Ohm, or in the range from one Ohm to two Ohms.

As shown in FIG. 3, in some example implementations, the voltage clamping component 303 includes a bidirectionally conductive TVS. During a surge test, at some time, the voltage on the first detection line 301 may be greater than the voltage on the second detection line 302, while at some other time, the voltage on the first detection line 301 may be less than the voltage on the second detection line 302. Thus, in such cases, the polarity of the voltage across the TVS cannot be guaranteed. By configuring the TVS to be bidirectionally conductive, the polarity of the voltage across the TVS will not affect the TVS.

As shown in FIG. 3, in some example implementations, the circuitry system 300 may further include at least one diode bridge, for example, a first diode bridge 305-1 and a second diode bridge 305-2, which are connected between four center taps and the first detection line 301, the second detection line 302. For example, as shown in FIG. 3, a first diode bridge 305-1 is connected between the CMT1, CMT2 and the first detection line 301 and the second detection line 302, and a second diode bridge 305-2 is connected between the CMT3, CMT4 and the first detection line 301 and the second detection line 302.

By providing this diode bridges 305-1 and 305-2, it can ensure that the positive and negative polarities of the voltage between the first detection line 301 and the second detection line 302 downstream of the diode bridges remain constant—for example, the voltage on the first detection line 301 is greater than the voltage on the second detection line 302. In this example implementation, the TVS is arranged between the diode bridges and the powered device chip 320, so that the positive and negative polarities of the voltage at both ends of the TVS remain constant by means of the diode bridges, and thus the TVS can be unidirectionally conductive.

Although as shown in FIG. 3, the voltage clamping component 303 is connected between the first detection line 301 and the second detection line 302, some other voltage clamping components may be provided between any two of center taps CMT1, CMT2, CMT3, and CMT4, such that the voltage input to the diode bridge is clamped to a target voltage, and thus the voltage between the first detection line 301 and the second detection line 302 is clamped to the target voltage less than rated voltage of the powered device chip 320.

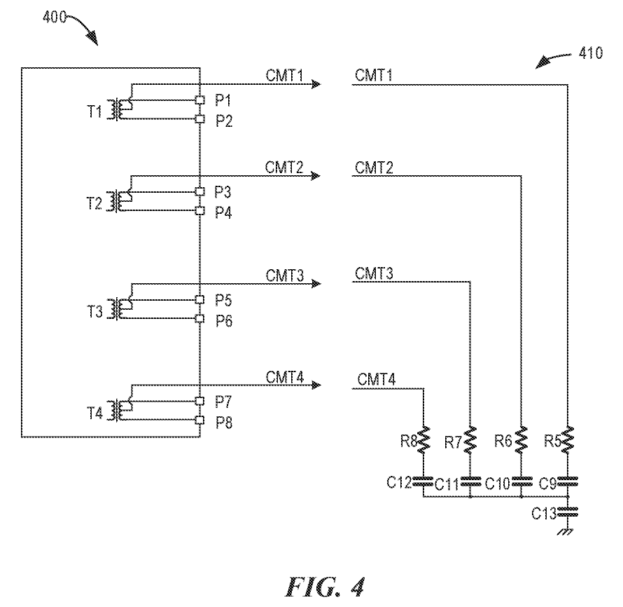

FIG. 4 shows a schematic view of a wireless device 400 having a common mode suppression circuit according to some example implementations of the present disclosure.

During data transmission, the center tap of the Ethernet terminal transformer also undertakes the important task of suppressing common-mode noise. Since Ethernet cables are susceptible to external electromagnetic interference and common-mode noise when transmitting signals, the center tap is connected to the corresponding common-mode suppression circuit 410 (such as a Bob Smith termination circuit), which can provide a low-impedance loop for the common-mode noise and guide the common-mode noise to the ground, thereby effectively suppressing the interference of the common-mode noise on the signal, and ensuring the accuracy and reliability of data transmission.

As shown in FIG. 4, the common mode suppression circuit 410 may include four resistors R5, R6, R7, and R8 (two for receiving RX and two for sending TX) and five capacitors C9, C10, C11, C12, and C13. As shown in FIG. 4, in the first branch connected to the CMT1, the resistor R5 and the capacitor C9 are connected in series. In the second branch connected to the CMT2, the resistor R6 and the capacitor C10 are connected in series. In the third branch connected to the CMT3, the resistor R7 and the capacitor C11 are connected in series. In the fourth branch connected to the CMT4, the resistor R8 and the capacitor C12 are connected in series. The above four branches are all grounded through the capacitor C13, and thus the center taps are grounded through the common mode suppression circuit 410. By grounding the center taps, the circuit can guide the common mode noise to the ground, thereby preventing the noise from propagating in the circuit and causing interference. At the same time, the combination of resistors and capacitors forms a filter, which helps to further attenuate the common mode noise.

In order to withstand the Hi-Pot test and the surge test, the capacitor C13 is also preferable to have the same capacity as the capacitors C1 and C2 shown in FIG. 3. For example, the capacitor C13 has a voltage capability of withstanding a voltage of 4kV. For example, the distance between the two pins of the capacitor C13 is greater than the creepage distance between the first detection line or the second detection line and the ground during the Hi-Pot test and the surge test.

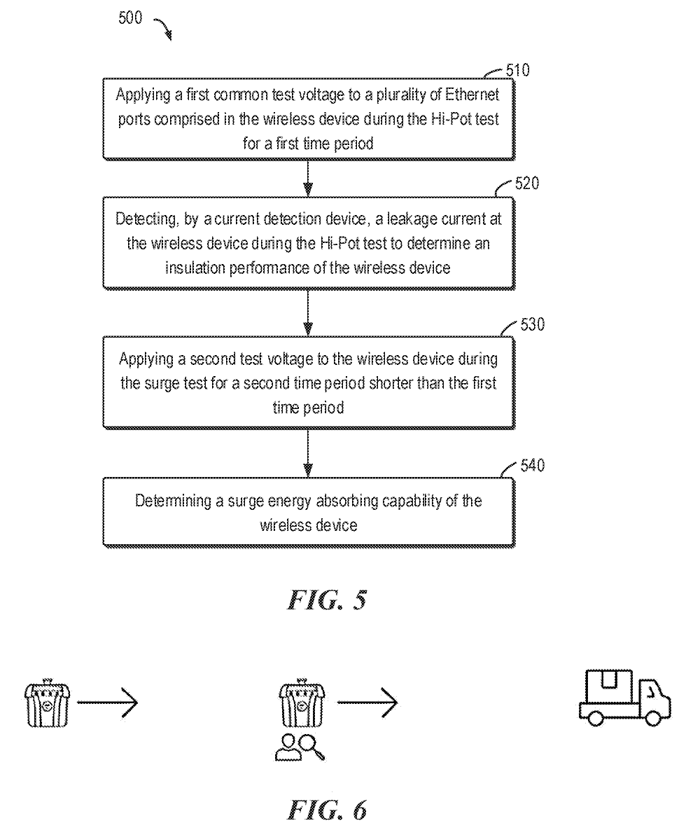

FIG. 5 is a schematic flow chart 500 for performing the Hi-Pot test and the surge test according to some example implementations of the present disclosure.

As shown in FIG. 5, at block 510, a first common test voltage (for example, 4kV) is applied to a number of Ethernet terminals included in the wireless device during the Hi-Pot test for a first time period (for example, at least 1 minute). During the Hi-Pot test, preferably, the plurality of Ethernet terminals is connected together, and a common test voltage is applied to all of them, for example, all eight ethernet terminals.

At block 520, the leakage current at the wireless device during the Hi-Pot test is detected by a current detection device to determine an insulation performance of the wireless device. Since there is no grounded TVS in the wireless device, the first test voltage will be applied directly to the components of the wireless device to verify the insulation performance thereof, instead of being diverted to the ground as in the conventional method, such that the insulation performance will be accurately determined.

At block 530, a second test voltage is applied to the wireless device (for example, eight Ethernet terminals) during the surge test for a second time period, which may be shorter than the first time period. Since the surge voltage is applied for a quite short time (for example, ten microseconds with one second interval therebetween) and the wireless device is still in working state, there may be a time difference (for example, at nanosecond level or at microsecond level) between a first time point of applying voltage to a first terminal and a second time point of applying voltage to a second terminal, such that there may be a voltage different between the first terminal and the second terminal at a certain time point.

At block 540, a surge energy absorbing capability of the wireless device may be determined through the surge test.

Thus, in the process 500, without disassembling or installing any components of the finished wireless device, the wireless device can subject to the Hi-Pot test to detect the insulation performance of its components by directly applying high voltage to the network terminals of the wireless device. In addition, by applying test voltage to the wireless device, the surge test can be performed directly with the surge energy being sufficiently absorbed.

FIG. 6 is a schematic view of performing a Hi-Pot test and a surge test according to some example implementations of the present disclosure.

As shown in FIG. 6, the wireless device according to some example implementations of the present disclosure no longer includes a grounded surge protection device. This way, during the Hi-Pot test, it is no longer necessary to remove the grounded surge protection device. Therefore, in the first step, all installations are completed, and other functional tests are passed (e.g., electromagnetic shielding test and surge protection test). In the second step, the Hi-Pot test is directly performed on the installed wireless device. In the third step, after passing the Hi-Pot test and the surge test, the entire wireless device is shipped. In the current method, the Hi-Pot test and the surge test can be performed without removing the surge protection device and reinstalling the surge protection device.

In the conventional method, the steps of disassembling and reinstalling surge protection devices (such as TVS) are relatively cumbersome and take a certain amount of time. When testing the wireless device according to some example implementations of the present disclosure, these steps are omitted, which can greatly shorten the test cycle, improve the test efficiency, and enable the wireless device to enter the distribution link. In addition, when testing the wireless device according to some example implementations of the present disclosure, on the one hand, labor costs are saved, and there is no need to arrange personnel to specifically perform the disassembly and installation operations of the device. On the other hand, the risk of device damage caused by disassembly and installation is reduced. The method disclosed in the present disclosure avoids these potential risks, maintains the original integrity and stability of the device, and helps to improve the reliability of the device in actual use. The method disclosed in the present disclosure does not require the disassembly and installation of a surge protection device, making the test process more concise and clearer, reducing the operation steps, and reducing the probability of errors in the test process.

In the context of this disclosure, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A circuitry system for a wireless device comprising a plurality of terminals and a powered device chip, comprising:
a first detection line connected between a first terminal of the plurality of terminals and the powered device chip, wherein the first terminal is configured to receive a first test voltage during a high potential (Hi-Pot) test or a surge test;
a second detection line connected between a second terminal of the plurality of terminals and the powered device chip, wherein the second terminal is configured to receive a second test voltage during the Hi-Pot test or the surge test, and a voltage difference between the first detection line and the second detection line is associated with a differential mode voltage between the first terminal and the second terminal;
a voltage clamping component connected between the first detection line and the second detection line and configured to clamp the voltage difference to be lower than a rated voltage of the powered device chip; and
a surge energy absorbing circuit configured to be connected to the first detection line and the second detection line to absorb surge energy during the surge test.

2. The circuitry system of claim 1, wherein the first terminal comprises one or more first center taps for one or more first Ethernet terminals comprised in the wireless device; and
wherein the second terminal comprises one or more second center taps for one or more second Ethernet terminals comprised in the wireless device.

3. The circuitry system of claim 2, wherein the first terminal comprises two first center taps for four first Ethernet terminals among eight Ethernet terminals of the wireless device; and
wherein the second terminal comprises two second center taps for four second Ethernet terminals among the eight Ethernet terminals of the wireless device.

4. The circuitry system of claim 3, wherein the eight Ethernet terminals are configured to be applied by a common voltage during the Hi-Pot test for a first time period; and
wherein at least one of the eight Ethernet terminals are configured to be applied by a surge voltage during the surge test for a second time period shorter than the first time period.

5. The circuitry system of claim 1, wherein the first test voltage is equal to the second test voltage during the Hi-Pot test; and
wherein the first test voltage is equal to or not equal to the second test voltage during the surge test.

6. The circuitry system of claim 1, wherein the voltage clamping component comprises a transient voltage suppressor (TVS), and
wherein the TVS is configured to:
operate in a cut-off state in the event that the differential mode voltage is less than a breakdown voltage of the TVS; and
operate in a reverse breakdown state in the event that the differential mode voltage is greater than or equal to the breakdown voltage to clamp the voltage difference between the first detection line and the second detection line at a target voltage that is lower than the rated voltage of the powered device chip.

7. The circuitry system of claim 1, wherein the surge energy absorbing circuit comprises:
a first inductor serially connected to the first detection line and the powered device chip;
a first capacitor connected between the first detection line and a ground;
a second inductor serially connected to the second detection line and the powered device chip; and
a second capacitor connected between the second detection line and the ground.

8. The circuitry system of claim 7, wherein each of the first capacitor and the second capacitor is configured to:
have a voltage capability of withstanding a voltage higher than a maximum voltage applied during the Hi-Pot test and the surge test; or
have a pin distance between two pins thereof larger than a creepage distance for the Hi-Pot test.

9. The circuitry system of claim 7, wherein each of the first inductor and the second inductor is configured to:
have a current through ability higher than a maximum current during the Hi-Pot test and the surge test.

10. The circuitry system of claim 1, further comprising a diode bridge connected to the first detection line and the second detection line.

11. The circuitry system of claim 10, wherein the circuitry system comprises a plurality of voltage clamping components;
wherein a first portion of the plurality of voltage clamping components is provided at a first side of the diode bridge; and
wherein a second portion of the plurality of voltage clamping components is provided at a second side of the diode bridge.

12. A wireless device comprising:
a plurality of terminals;
a powered device chip; and
a circuitry system comprising:
a first detection line connected between a first terminal of the plurality of terminals and the powered device chip, wherein the first terminal is configured to receive a first test voltage during a high potential (Hi-Pot) test or a surge test;
a second detection line connected between a second terminal of the plurality of terminals and the powered device chip, wherein the second terminal is configured to receive a second test voltage during the Hi-Pot test or the surge test, and a voltage difference between the first detection line and the second detection line is associated with a differential mode voltage between the first terminal and the second terminal;
a voltage clamping component connected between the first detection line and the second detection line and configured to clamp the voltage difference to be lower than a rated voltage of the powered device chip; and
a surge energy absorbing circuit configured to be connected to the first detection line and the second detection line to absorb surge energy during the surge test.

13. The wireless device of claim 12, wherein the first terminal comprises one or more first center taps for one or more first Ethernet terminals comprised in the wireless device; and
wherein the second terminal comprises one or more second center taps for one or more second Ethernet terminals comprised in the wireless device.

14. The wireless device of claim 13, wherein the one or more first Ethernet terminals and the one or more second Ethernet terminals are configured to be applied by a common voltage during the Hi-Pot test for a first time period; and
wherein at least one of the one or more first Ethernet terminals and the one or more second Ethernet terminals is configured to be applied by a surge voltage during the surge test for a second time period shorter than the first time period.

15. The wireless device of claim 12, wherein the first test voltage is equal to the second test voltage during the Hi-Pot test; and
wherein the first test voltage is equal to or not equal to the second test voltage during the surge test.

16. The wireless device of claim 12, wherein the voltage clamping component comprises a transient voltage suppressor (TVS), and
wherein the TVS is configured to:
operate in a cut-off state in the event that the differential mode voltage is less than a breakdown voltage of the TVS; and
operate in a reverse breakdown state in the event that the differential mode voltage is greater than or equal to the breakdown voltage to clamp the voltage difference between the first detection line and the second detection line at a target voltage that is lower than the rated voltage of the powered device chip.

17. The wireless device of claim 12, wherein the surge energy absorbing circuit comprises:
a first inductor serially connected to the first detection line and the powered device chip;
a first capacitor connected between the first detection line and a ground;
a second inductor serially connected to the second detection line and the powered device chip; and
a second capacitor connected between the second detection line and the ground.

18. The wireless device of claim 17, wherein each of the first capacitor and the second capacitor is configured to:
have a voltage capability of withstanding a voltage higher than a maximum voltage applied during the Hi-Pot test and the surge test; or
have a pin distance between two pins thereof larger than a creepage distance for the Hi-Pot test.

19. The wireless device of claim 17, wherein each of the first inductor and the second inductor is configured to:
have a current through ability higher than a maximum current during the Hi-Pot test and the surge test.

20. A method for performing a high potential (Hi-Pot) test and a surge test on a wireless device comprising:
applying a first common test voltage to a plurality of Ethernet terminals comprised in the wireless device during the Hi-Pot test for a first time period;
detecting, by a current detection device, a leakage current at the wireless device during the Hi-Pot test to determine an insulation performance of the wireless device;
applying a second test voltage to the wireless device during the surge test for a second time period shorter than the first time period; and
determining a surge energy absorbing capability of the wireless device.
